(19) United States
(12) Patent Application Publication
(10) Pub. No.: US 2022/0272887 A1
(43) Pub. Date: Sep. 1, 2022

(54) Implement with Interchangeable Rotary Drum

(71) Applicant: Paul Deron Kudick, Merrill, WI (US)

(72) Inventor: Paul Deron Kudick, Merrill, WI (US)

(73) Assignee: Merrill Tool & Water Jet, LLC, Merrill, WI (US)

(21) Appl. No.: 17/681,120

(22) Filed: Feb. 25, 2022

Related U.S. Application Data
(60) Provisional application No. 63/155,053, filed on Mar. 1, 2021.

(51) Int. Cl. A01B 29/06; A01B 29/04

(52) U.S. Cl. CPC A01B 29/06; A01B 29/045

(57) ABSTRACT

An implement with an interchangeable rotor for vehicles, such as skid-steer loaders, tractors, walk, ride, or pull behind power equipment, and the like, with an interchangeable or replaceable surface engaging rotary drum. The implement includes a support frame, a drive transmission assembly, a surface engaging rotary drum, and a removable idler carrier assembly. The implement incorporates a mechanical linkage for transmitting torque and supporting rotor mounting components to allow the rotating surface engaging rotary drum to be quickly and easily removed from the implement frame to either be serviced or interchanged with a rotor designed for a different application and then reattached.

### CROSS-REFERENCE TO RELATED APPLICATION

This application is based upon and claims the benefit of U.S. Provisional Application Ser. No. 63/155,053, filed Mar. 1, 2021.

### BACKGROUND OF THE INVENTION

The invention disclosed herein relates to an implement for use with vehicles such as skid-steer loaders, tractors, and other vehicles and, more specifically, to an improvement for a surface engaging rotary drum implement with a replaceable or interchangeable rotary drum. The present invention also includes a method of rotary power transmission for equipment used with skid-steer loaders, tractors, walk, ride, or pull behind power equipment, or similar such vehicles. The present invention provides an implement with a ground-engaging rotor drum that is configured to use an interchangeable rotor drum that may be quickly and easily replaced, interchanged, or exchanged.

Ground-engaging implements in various forms for vehicles such as skid-steer loaders, tractors with a power take-off shaft, and walk, ride, or pull behind power equipment have been utilized for leveling, tilling and winnowing field debris for many years. Such implements typically comprise a horizontally-mounted rotor drum attached to a support assembly that includes attachment apparatus for securing the implement to a skid-steer loader, tractor, walk, ride, or pull behind power equipment, or similar such vehicle. The rotor drum includes a surface with any of a variety of surface teeth, tines, brushes and the like and can be lowered to engage the surface of the ground. By using different tool attachments on the surface engaging horizontal rotor, different outcomes are achievable dependent upon the desired end result. Examples of the various surface engaging rotor applications include, but are not limited to, scarifying and leveling a surface with protruding or forward swept teeth (defined by rotary direction of the surface engaging rotor drum), raking and winnowing surface debris with protruding teeth, surface sweeping bristles or brushes, and subsurface rototilling or cultivating tines.

In prior art embodiments of such implements, when the rotor drum of the implement needed to he removed for maintenance or replacement, the user generally was required to disassemble a significant portion of the implement (such as removing motors or gears, covers, bearings and other supporting components), dean ground debris from portions of the implement to free components for removal, and remove lubricants from the implement before being able to detach the rotor from the implement frame for replacement or to exchange the rotor for another having a different purpose. For example, in some prior art implements, the drum assembly may be replaced, but in order to do so, the user must remove the direct drive motor in addition to other components of the implement in order to replace the rotor assembly. This is similar to typical prior art designs where, in order to replace a rotor drum, the power transfer components, bearings, and support assembly of the rotor drum must all be disassembled in order to remove the rotor drum itself. As such, operations such as these are labor and time intensive, often requiring several hours of time to complete, Likewise, with prior art implements, such operations typically have not been practical or reasonable to complete in the field; instead, such operations usually are required to be completed in a shop with the required equipment and tools necessary to disassemble and reassemble the components of the implement.

Most end users have found it to be more effective to own or rent entirely separate implements with rotor tooling specific to a particular application rather than changing the rotor on the implement frame each time a different rotor is needed for a different purpose. Thus, there is a need for an implement design that allows the end user to quickly and easily change the rotor drum on the implement frame.

Therefore, there is a need for an implement that includes a system for quickly and easily replacing, interchanging, or exchanging the rotor drum of the implement without requiring significant disassembly of the implement. The present invention satisfies such a need. One embodiment of the present invention incorporates an implement frame design in conjunction with a rotary power transmission method to improve the time efficiency of rotor tool replacement or interchangeability. The ability to change the rotor drum in a time efficient manner will allow end users the flexibility of choosing application-specific surface engaging tools to achieve the desired result or purpose, while allowing them to purchase and use one implement (rather than a variety of implements intended for different uses, thus also allowing the end user to save money and be more efficient). For example, the implement may he used as a traditional power rake for landscaping during the summer and then changed over to a snow removal broom or brush for sweeping snow and ice in the winter. Another example is that the implement may be used with a roto tine assembly to roughly till soil to prepare the ground for landscaping and then the rotor can be changed to a traditional power rake to break up and level the tilled soil to prepare the ground for seeding, with only a small amount of time and effort required to change the implement from one use to the other on the work site. The design of the present invention makes it more cost efficient to have several different application-specific rotor drums on hand to use with the same implement frame, rather than having multiple implements that have different configurations for different work purposes.

### BRIEF SUMMARY OF THE INVENTION

It is a feature of the present invention to provide an implement for use with vehicles such as skid-steer loaders, tractors, walk, ride, or pull behind power equipment and, more specifically, to an improvement for a surface engaging rotary drum implement that allows for greater efficiency through quick and easy rotary drum replacement or interchangeability.

The implement 10 of the present invention includes a support frame 12, a drive transmission assembly 14, a surface engaging rotary drum 16, and an idler carrier assembly 18. The implement 10 of the present invention also includes an attachment mount 76, the form and configuration of which varies in accordance with the type of equipment (skid-steer loader, tractor, walk, ride, or pull behind power equipment, or other such vehicle) that the implement 10 will be utilized with.

The support frame 12 and implement 10 may he pushed by a skid-steer loader (or walk, ride, or pull behind power equipment) or similar such vehicle or pulled by a tractor which incorporates a method of transmitting torque from the vehicle to the surface engaging rotary drum 16. Preferably, the support frame 12 is mounted such that the rotary drum's longitudinal axis is substantially parallel to the surface of the ground on which the implement 10 will be used, as that configuration is typical with such uses. However, nothing in the present invention would prevent the support frame 12 from being mounted at an angle other than parallel to the surface with which it will be used, or from having an adjustable configuration where the angle may be varied. The support frame 12 and implement 10 is designed to allow the rotary drum 16 to be adjusted to run at an angle to or perpendicular to the direction of travel of the vehicle when the implement is operated with a skid-steer loader, tractor, walk, ride, or pull behind power equipment, or similar such vehicle.

The support frame 12 includes a horizontal support bar 20, a drive side support plate 22, and an idler side support plate 24. The attachment mount 76 is secured to the horizontal support bar 20 of the support frame 12 and includes any hardware necessary to attach the implement 10 to the skid-steer loader, tractor, walk, ride, or pull behind power equipment, or similar such vehicle.

The drive transmission assembly 14 is secured to the drive side end of the support frame 12, and, more specifically, to the drive side support plate 22. The drive transmission assembly 14 may take the form of any power transmission device known in the art for transmitting the rotational power from the vehicle or equipment to which the implement 10 is attached (such as a skid-steer loader, tractor, walk, ride, or pull behind power equipment, or other such vehicle), such that when the power generating device of the vehicle or equipment (such as a hydraulic motor pump, motor and belt drive, or power take-off shaft) is engaged and rotates, the rotational power is transferred to the surface engaging rotary drum 16, thereby causing the rotary drum 16 to rotate, Alternatively, particularly in the case of walk behind, pull behind, or ride behind power equipment, the implement 10 may include a power source, such as a motor, that is used to rotate the rotary drum 16 directly, such that the implement i.s self-powered and a vehicular power system is not necessary. Typically, the drive transmission assembly 14 takes the form of a coupler that receives an equipment drive spindle from the power generating device of the equipment or vehicle. The coupler is attached to a transmission sprocket, which rotates as the equipment drive spindle of the power generating device of the equipment or vehicle rotates. The drive transmission assembly 14 also includes a drive sprocket with key 26 that receives a drive spindle 28 with a drive spindle keyway 30 that engages a key within the drive sprocket with key 26. The drive spindle 28 extends through a drive bearing assembly 32, which includes a drive bearing 34 that allows the drive spindle 28 to rotate relative to the drive transmission assembly 14 (thereby rotating the rotary drum 16) and a drive hearing housing 36 which supports, positions, and protects the drive bearing 34 from dirt and debris. The drive bearing 34 is configured such that the drive spindle 28 may angle downward relative to the horizontal, thereby aiding in the removal of the rotary drum 16 pursuant to the present invention. The drive transmission assembly 14 further comprises a drive chain 38, or alternatively a drive belt, that engages both the transmission sprocket and the drive sprocket with key 26 and stretches between them, thereby causing the drive sprocket with key 26 to rotate when the transmission sprocket is rotated by the coupler and the power generating device of the equipment or vehicle, which in turn causes the drive spindle 28 to rotate and causes the surface engaging rotary drum 16 to rotate as well.

The drive spindle 28 also includes a male coupler 40 that engages the surface engaging rotary drum 16. The male coupler 40 can have a variety of shapes or configurations for engaging the surface engaging rotary drum 16. For example, in one embodiment of the present invention, it has an eight-lobed spline configuration.

The surface engaging rotary drum 16 includes surface engagement tooling 42, an idler side rotor hub assembly 44, and a drive side rotor hub assembly 46. The surface engaging rotary drum 16 is designed to perform surface engagement work by means of axial rotation and has the surface engagement tooling 42 mounted on the outside circumference of the rotary drum to achieve the desired result on the surface of the ground. The surface engagement tooling 42 may take any form for such tooling known in the art, including, but not limited to, Y-shaped teeth, straight teeth, angled teeth, carbide tips, replaceable teeth, brooms or brushes, paddles, tines, and other similar tooling. The specific surface engagement tooling 42 used on the surface engaging rotary drum 16 may be selected in accordance with the desired processing of the surface to be done or the desired outcome of the completed work.

The drive side rotor hub assembly 46 comprises an inner rotary drum spacer 48 and an outer rotary drum spacer 50, both of which are located within the rotary drum 16 and secure the drive side rotor hub assembly 46 to the rotary drum 16. The drive side rotor hub assembly 46 also includes the drive spindle receiving tube 52, which is cylindrical in shape and receives the drive spindle 28 of the drive transmission assembly 14. The drive side rotor hub assembly 46 further comprises a female coupler 54, which is secured to and centered on the outer rotary drum spacer 50 for receiving the male coupler 40 of the drive spindle 28. The female coupler 54 has a shape or configuration that corresponds with the shape or configuration of the male coupler 40 of the drive spindle 28, such that the male coupler 40 may be received by and transmit rotational power to the surface engaging rotary drum 16, For example, in one embodiment of the present invention, the female coupler 54 has an eight-lobed spline configuration that corresponds with the eight-lobed spline configuration of the male coupler 40. Thus, the male coupler 40 of the drive spindle 28 and the female coupler 54 of the drive side rotor hub assembly 46 constitute a means of linkage for transmitting torque and rotational power to the surface engaging rotary drum 16, while also providing a means of release for the rotary drum 16.

While one preferred embodiment of the implement 10 of the present invention includes a drive side rotor hub assembly 46 comprising a total of two spacers—the inner rotary drum spacer 48 and the outer rotary drum spacer 50—alternatively, a plurality of spacers may be utilized. For example, where additional strength is required, or where a longer drive spindle 28 is utilized, the drive side rotor hub assembly 46 may comprise three or more spacers in a variety of configurations. Where such a plurality of spacers is utilized, the outermost spacer will continue to have the same configuration and components as the outer rotary drum spacer 50, while the other spacers typically will have the same (or very similar) configuration and components as the inner rotary drum spacer 48.

The female coupler 54 has an accepting cavity that is shaped to correspond and be congruent to fit the perimeter of the shape of the male coupler 40 (for example, the eight-lobed spline shape discussed in connection with one embodiment of the present invention). The depth of the receiving cavity of the female coupler 54 is predetermined to provide for adequate engagement of the male coupler 40 of the drive spindle 28 to allow the drive spindle 28 to engage and rotate the surface engaging rotary drum 16.

Similarly, the idler side rotor hub assembly 44 comprises an inner rotary drum spacer 56 and an outer rotary drum spacer 58, both of which are located within the surface engaging rotary drum 16 and secure the idler side rotor hub assembly 44 to the rotary drum 16. The idler side rotor hub assembly 44 also includes an idler spindle receiving tube 60, which is cylindrical in shape and receives an idler spindle 62 of the idler carrier assembly 18. The idler side rotor hub assembly 44 further comprises a female coupler 64, which is secured to and centered on the outer rotary drum spacer 58 for receiving a male coupler 66 of the idler spindle 62. The female coupler 64 has a shape or configuration that corresponds with the shape or configuration of the male coupler 66 of the idler spindle 62, such that the male coupler 66 may be received by the surface engaging rotary drum 16. For example, in one embodiment of the present invention, the female coupler 64 has an eight-lobed spline configuration that corresponds with an eight-lobed spline configuration of the male coupler 66. Thus, the male coupler 66 of the idler spindle 62 and the female coupler 64 of the idler side rotor hub assembly 44 constitute a means of linkage, while also providing a means of release for the surface engaging rotary drum 16.

While one preferred embodiment of the implement 10 of the present invention includes an idler side rotor hub assembly 44 comprising a total of two spacers—the inner rotary drum spacer 56 and the outer rotary drum spacer 58—alternatively, a plurality of spacers may be utilized. For example, where additional strength is required, or where a longer idler spindle 62 is utilized, the drive side rotor hub assembly 46 may comprise three or more spacers in a variety of configurations. Where such a plurality of spacers is utilized, the outermost spacer will continue to have the same configuration and components as the outer rotary drum spacer 58, while the other spacers typically will have the same (or very similar) configuration and components as the inner rotary drum spacer 56.

The female coupler 64 has an accepting cavity that is shaped to correspond and be congruent to fit the perimeter of the shape of the male coupler 66 (for example, the eight-lobed spline shape discussed in connection with one embodiment of the present invention). The depth of the receiving cavity of the female coupler 64 is predetermined to provide for adequate engagement of the male coupler 66 of the idler spindle 62.

The idler spindle 62 also includes the male coupler 66 that engages the surface engaging rotary drum. 16. The male coupler 66 can have a variety of shapes or configurations for engaging the surface engaging rotary drum 16. For example, in one embodiment of the present invention, it has an eight-lobed spline configuration.

The idler carrier assembly 18 is removably secured to the idler side end of the support frame 12, more specifically to the idler side support plate 24. The idler carrier assembly 18 is removably secured to the idler side support plate 24 with a plurality of bolts 68, which may be removed to allow the idler carrier assembly 18 to be removed from the idler side support plate 24 to remove or exchange the surface engaging rotary drum 16. The idler carrier assembly 18 also includes an idler bearing assembly 70, which includes an idler bearing 72 that allows the idler spindle 62 to rotate relative to the idler carrier assembly 18 (thereby also allowing the rotary drum 16 to rotate) and an idler bearing housing 74 which supports, positions, and protects the idler bearing 72 from dirt and debris. The idler spindle 62 extends through the idler bearing 72 and into the idler spindle receiving tube 60 of the idler side rotor hub assembly 44. Preferably, the idler bearing 72 is configured such that the idler spindle 62 may be angled relative to the horizontal, as such angling of the idler spindle 62 aids in the removal of the idler carrier assembly 18 pursuant to the present invention. However, alternatively, the idler bearing 72 may be configured to have a fixed horizontal configuration, such that it does not and can not be angled relative to the horizontal, while not departing from the scope of the present invention, as such a configuration still allows the removal of the idler carrier assembly 18 with some additional effort.

To attach the surface engaging rotary drum 16 to the support frame 12 (and therefore the implement 10 of the present invention), the drive spindle 28 is inserted into the drive spindle receiving tube 52 of the drive side rotor hub assembly 46. The male coupler 40 of the drive spindle 28 may be rotated as necessary to fit into and be engaged by the female coupler 54 of the drive side rotor hub assembly 46. After mating the drive spindle 28 with the drive side rotor hub assembly 46, the surface engaging rotary drum 16 is re-positioned under the support frame 12 to be approximately parallel to and beneath the horizontal support bar 20 of the support frame 12. Next, the idler carrier assembly 18 with the idler spindle 62 is positioned to allow the idler spindle 62 to be inserted into the spindle receiving tube 60 of the idler side rotor hub assembly 44. The idler carrier assembly 18 is adjusted such that the alignment apertures of the idler carrier assembly 18 match the positions of the corresponding alignment pins located on the idler side support plate 24 of the support frame 12. After aligning the alignment apertures with the corresponding alignment pins, the male coupler 66 of the idler spindle 62 may be rotated as necessary to fit into and be engaged by the female coupler 64 of the idler side rotor hub assembly 44. After the idler side rotor hub assembly 44 and the idler spindle 62 have been mated, the bolts or fasteners are used to attach and secure the idler carrier assembly 18 to the idler side support plate 24 of the support frame 12, thereby securing the surface engaging rotary drum 16 to the implement 10.

Fastening the idler carrier assembly 18 to the idler side support plate 24 results in sandwiching the drive spindle 28, idler spindle 62, and surface engaging rotary drum 16 between the drive side support plate 22 (and drive transmission assembly 14) and the idler side support plate 24 within the support frame 12 of the implement 10. This completed assembly allows torque to be transmitted from the implement's rotational power supply, through the drive transmission assembly 14, and then through the drive spindle 28 to the surface engaging rotary drum 16 to impart rotational energy to the surface engaging rotary drum 16 to perform the desired work.

Thus, the design of the implement 10 of the present invention allows an end user to replace, interchange, or exchange rotary drums by removing the fasteners attaching the idler carrier assembly 18 to the idler side support plate 24 of the support frame 12 and then moving the idler carrier assembly 18 longitudinally away from the idler side support plate 24. This movement allows for the removal of the idler spindle 62 from the idler side rotor hub assembly 44. The drive bearing 34 and drive bearing housing 36 then allows the drive spindle 28 to pitch slightly downward relative to the horizontal plane. The resulting downward shift of the surface engaging rotary drum 16 on the opposite end (nearest the idler side support plate 24 of the support frame 12) provides enough clearance to allow the surface engaging rotary drum 16 to longitudinally slide off of, and disengage from, the drive spindle 28. Once the surface engaging rotary drum 16 has been removed from the implement 10, service may be performed on the rotary drum 16 or a different application specific rotary drum 16 may be installed on the implement 10 by reversing the preceding procedure.

The design of the implement 10 of the present invention improves efficiency of the time required to change the surface engaging rotary drum 16 on the implement 10 when compared to prior art implements of a similar type. The time needed to disassemble, remove and replace the rotary drum 16 and then reassemble the same has been decreased to approximately twenty (20) minutes using the design of the implement 10 of the present invention from the typical two (2) to four (4) hours required to complete the similar process with a traditional prior art implement of a comparable type. This efficiency and time savings, together with the additional benefit of a rotary drum replacement or interchangeability option, allows an end user to be more cost efficient with their use of implements by providing a practical means of selecting different rotary drums 16 for use on the same implement 10, rather than requiring entirely different implements for different purposes or uses.

The benefit of the design of the implement 10 of the present invention relies upon three factors that together cooperate to improve the time efficiency of the assembly and disassembly of the implement 10 for replacement of the rotary drum 16 or to interchange one rotary drum 16 for another. First, the support frame 12 includes a design that allows the quick removal of the idler carrier assembly 18, but is still able to maintain the required rigidity to support the rotary drum 16. Secondly, the incorporation of a drive bearing assembly 32 and a drive spindle 28 with the means to reposition the bearing bore, thereby allowing a downward pitch of the rotary drum 16 without requiring any of the drive transmission assembly 14 or drive bearing assembly 32 components to be disassembled, allows for the quick and easy replacement or interchange of the rotary drum 16. Thirdly and finally the implement 10 of the present invention includes a coupling method for torque transmission and acceptance to the rotary drum 16 while providing an expedient male to female coupling linkage (via the male coupler 40 of the drive spindle 28, the female coupler 54 of the drive side rotor hub assembly 46, the female coupler 64 of the idler side rotor hub assembly 44, and the male coupler 66 of the idler spindle 62) for simple and time efficient rotary drum removal and reassembly. The combination of these three factors results in a significant improvement of time efficiency of the assembly and disassembly of the rotary drum 16, thereby making the implement 10 of the present invention more cost efficient to manufacture and utilize than existing prior art implements of a similar purpose.

While a number of exemplar devices that may be used with the implement 10 of the present invention are disclosed herein, the implement 10 of the present invention may be used with many different general forms and types of equipment where the implement 1.0 includes a rotary drum 16 for engaging a surface. The description herein serves to illustrate an exemplary embodiment of the implement 10 of the present invention and it should be noted by those skilled in the art that the disclosures herein are exemplary only, and that various other alternatives, adaptations, and modifications may be made within the scope of the present invention. Many modifications and other embodiments will come to mind to one skilled in the art to which the present invention pertains having the benefit of the teaching presented in the foregoing descriptions and the associated drawings. Although specific terms may be employed herein, they are used in a generic and descriptive sense only and not for purposes of limitation. Accordingly, the present disclosure is not limited to the specific embodiments illustrated herein.

### BRIEF DESCRIPTION OF THE DRAWINGS

FIG. 1 shows a preferred embodiment of the implement of the present invention attached to a skid-steer loader vehicle.

FIG. 2 shows a preferred embodiment of the implement of the present invention attached to a tractor.

FIG. 3 shows a front elevation view of the implement of FIG. 1 showing the idler carrier assembly in its removed configuration.

FIG. 4 shows a front elevation view of the implement of FIG. 1 with the idler carrier assembly removed, illustrating the removal of the surface engaging rotary drum.

FIG. 5 shows a side elevation view of the drive transmission assembly of the implement of FIG. 1 with access covers removed to show the internal structure thereof.

FIG. 6a shows a perspective view of the drive spindle of the implement of FIG. 1.

FIG. 6b shows an exploded perspective view of the drive spindle of the implement of FIG. 1 showing the male coupler.

FIG. 7a shows a perspective view of the idler spindle of the implement of FIG. 1.

FIG. 7b shows an exploded, perspective view of the idler spindle of the implement of FIG. 1 showing the male coupler.

FIG. 8a shows a perspective view of the design of the drive side rotor hub assembly and the idler side rotor hub assembly of the implement of FIG. 1.

FIG. 8b shows an exploded perspective view of the design of the drive side rotor hub assembly and the idler side rotor hub assembly of the implement of FIG. 1 showing the female coupler, outer rotary drum spacer, spindle receiving tube, and inner rotary drum spacer of each.

FIG. 9a shows a perspective view of the surface engaging rotary drum of the implement of FIG. 1 with a cut-away showing the location and configuration of the idler side rotor hub assembly taken along line 9a-9a of FIG. 9b.

FIG. 9b shows a cross-sectional view of the surface engaging rotary drum of the implement of FIG. 1 taken along the centerline of the surface engaging rotary drum showing the locations of the drive side rotor hub assembly and the idler side rotor hub assembly.

FIG. 10 shows a perspective view of the interconnection between the drive transmission assembly, drive spindle, and drive side of the surface engaging rotary drum of the implement of FIG. 1, shown as the surface engaging rotary drum is being connected to the implement of FIG. 1.

FIG. 11 shows a close-up front elevation view of the interconnection between the drive transmission assembly, drive spindle, and drive side of the surface engaging rotary drum of the implement of FIG. 1, shown with the surface engaging rotary drum in its connected configuration, with the surface engaging rotary drum still at an angle to the support frame.

FIG. 12 shows a front elevation view of the interconnection between the drive transmission assembly, drive spindle, and drive side of the surface engaging rotary drum of the implement of FIG. 1, shown with the surface engaging rotary drum in its connected configuration, but prior to the surface engaging rotary drum being attached to the idler spindle, and idler carrier assembly, with the surface engaging rotary drum still at an angle to the support frame.

FIG. 13 shows a close-up front elevation view of the interconnection between the drive transmission assembly, drive spindle, and drive side of the surface engaging rotary drum of the implement of FIG. 1, shown with the surface engaging rotary drum in its connected and horizontal configuration, but prior to the surface engaging rotary drum being attached to the idler spindle, and idler carrier assembly.

FIG. 14 shows a front elevation view of the interconnection between the drive transmission assembly, drive spindle, and drive side of the surface engaging rotary drum of the implement of FIG. 1, shown with the surface engaging rotary drum in its connected and horizontal configuration, but prior to the surface engaging rotary drum being attached to the idler spindle.

FIG. 15 shows a perspective view of the interconnection between the idler carrier assembly, idler spindle, and idler side of the surface engaging rotary drum of the implement of FIG. 1, shown prior to the surface engaging rotary drum being attached to the idler spindle.

FIG. 16 shows a perspective view of the interconnection between the idler carrier assembly, idler spindle, and idler side of the surface engaging rotary drum of the implement of FIG. 1, shown when the surface engaging rotary drum has been attached to the idler spindle, but prior to the idler carrier assembly being secured to the idler side support plate.

FIG. 17a shows a perspective view of exemplar surface engagement tooling of the surface engaging rotary drum of the implement of FIG. 1, shown with surface engagement tooling with Y-shaped teeth.

FIG. 17b shows a side elevation view of the exemplar surface engagement tooling of the surface engaging rotary drum of FIG. 17a.

FIG. 18a shows a perspective view of exemplar surface engagement tooling of the surface engaging rotary drum of the implement of FIG. 1, shown with surface engagement tooling with replaceable teeth.

FIG. 18b shows a side elevation view of the exemplar surface engagement tooling of the surface engaging rotary drum of FIG. 18a.

FIG. 19a shows a perspective view of exemplar surface engagement tooling of the surface engaging rotary drum of the implement of FIG. 1, shown with surface engagement tooling with paddle brushes.

FIG. 19b shows a side elevation view of the exemplar surface engagement tooling of the surface engaging rotary drum of FIG. 19a.

FIG. 20a shows a perspective view of exemplar surface engagement tooling of the surface engaging rotary drum of the implement of FIG. 1, shown with surface engagement tooling with carbide-tipped teeth.

FIG. 20b shows a side elevation view of the exemplar surface engagement tooling of the surface engaging rotary drum of FIG. 20a.

FIG. 21a shows a perspective view of exemplar surface engagement tooling of the surface engaging rotary drum of the implement of FIG. 1, shown with surface engagement tooling with broom brushes.

FIG. 21b shows a side elevation view of the exemplar surface engagement tooling of the surface engaging rotary drum of FIG. 21a.

FIG. 22a shows a perspective view of exemplar surface engagement tooling of the surface engaging rotary drum of the implement of FIG. 1, shown with surface engagement tooling with roto tines.

FIG. 22b shows a side elevation view of the exemplar surface engagement tooling of the surface engaging rotary drum of FIG. 22a.

### DETAILED DESCRIPTION OF THE PREFERRED EMBODIMENT(S)

Embodiments of the present invention provide an implement 110 for use with vehicles such as skid-steer loaders, tractors, walk, ride, or pull behind power equipment, and similar vehicles, which allows the rotary drum or rotor of the implement to be quickly and easily removed for service or to be interchanged with a rotary drum having a different use or purpose.

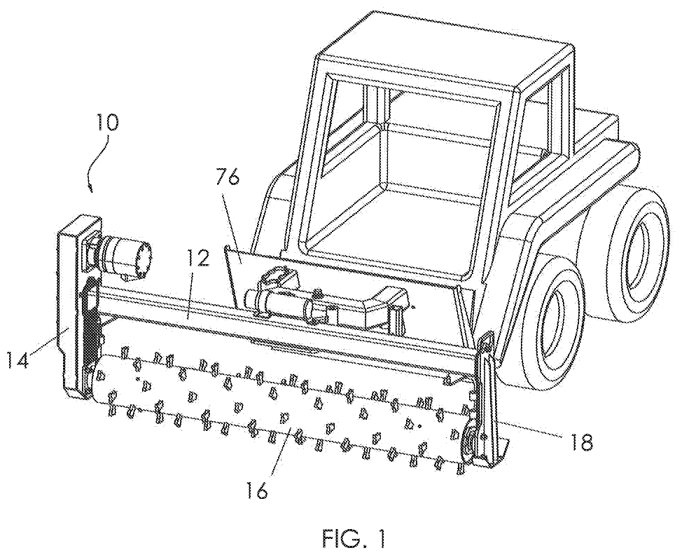

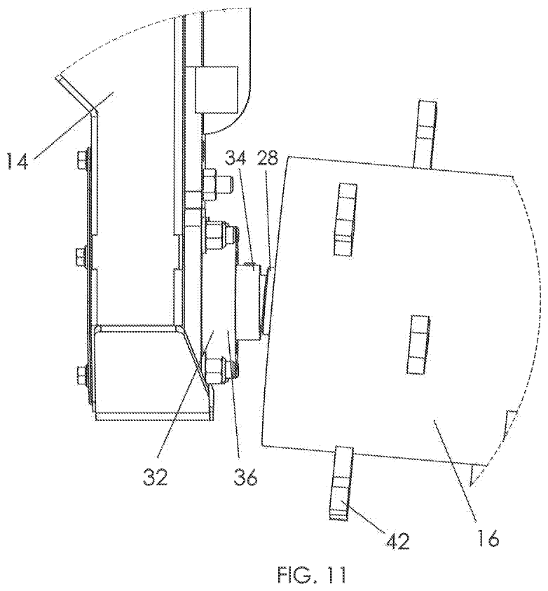

Referring now to FIGS. 1-22b, one preferred embodiment of an implement 10 of the present invention is shown. This embodiment of the implement 10 includes the support frame 12, the drive transmission assembly 14, the surface engaging rotary drum 16, and the idler carrier assembly 18.

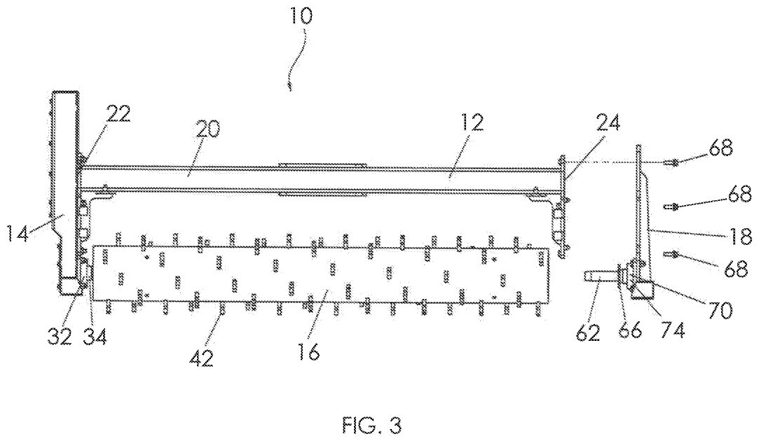

The support frame 12 includes the horizontal support bar 20, the drive side support plate 22, and the idler side support plate 24. The drive side support plate 22 and the idler side support plate 24 are attached to opposite ends of the horizontal support bar 20 and extend downward from the horizontal support bar 20. While the drive side support plate 22 and the idler side support plate 24 may be angled relative to the horizontal support bar 20, the drive side support plate 22 and the idler side support plate 24 are preferably perpendicular to the horizontal support bar 20, as best shown in FIG. 3.

The implement 10 also includes an attachment mount 76, the form and configuration of which corresponds with a standard mounting system for the types of vehicles and equipment with which it is to be utilized (skid-steer loaders, tractors, walk, ride, or pull behind power equipment, or other such vehicles). Such vehicles typically have a universal mounting adapter or a three-point hitch system that allows the attachment of various standard equipment having the corresponding standard mounting system. The attachment mount 76 of the implement 10 of the current invention includes such a standard mounting system, which is widely known in the art. Alternatively, particularly in the case of walk, ride, or pull behind power equipment, the implement may be integrated directly into the vehicle itself or the implement may be self-powered with a power source (such as a motor) mounted on the implement itself. However, any attachment mount 76 designed to correspond with the specific type of vehicle with which the implement 10 will be used may be used without departing from the scope of the present invention. The attachment mount 76 is preferably secured to the horizontal support bar 20 of the support frame 12.

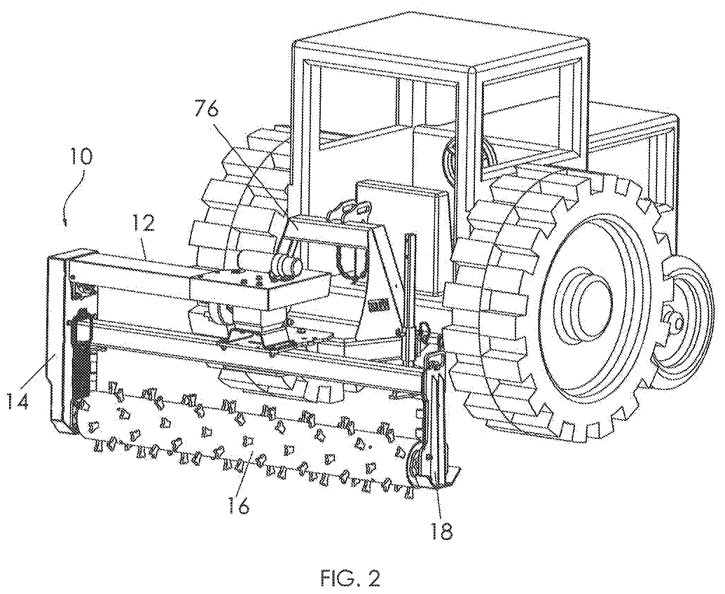

The support frame 12, and therefore the implement 10, is designed to support the other components of the implement 10 and to either be pushed by a skid-steer loader (as best shown in FIG. 1) or walk, ride, or pull behind power equipment (or similar such vehicle) or pulled by a tractor (as best shown in FIG. 2) or similar such vehicle which incorporates a method of transmitting torque to the surface engaging rotary drum 16, such as a hydraulic power system of a skid-steer loader or a power take-off system of a tractor, or other such similar power transmission system.

Preferably, the support frame 12 is mounted such that the longitudinal axis of the horizontal support bar 20 is substantially parallel to the surface the implement 10 will be used to process, as that configuration is typical with such uses. However, the support frame 12 may alternatively be mounted at an angle other than parallel to the surface with which it will be used, or may have an adjustable configuration where the angle may be varied, without departing from the scope of the present invention.

The support frame 12 is designed to allow the rotary drum 16 to be adjusted to run at an angle to or perpendicular to the direction of travel of the vehicle when the implement is operated with a skid-steer loader, tractor, walk, ride, or pull behind power equipment, or similar such vehicle. That is, the support frame 12 is positioned such that the surface engaging rotary drum 16 is perpendicular to the direction of travel of the vehicle, or may be repositioned or adjusted such that the surface engaging rotary drum 16 is at an angle (thirty degrees, forty-five degrees, or sixty degrees, for example) to the direction of travel of the vehicle. This ability to adjust the angle of the rotary drum 16 allows the end user to control the direction in which the rotary drum 16 deposits material that has been processed.

Torque from the vehicle to which the implement 10 is attached is transmitted to the surface engaging rotary drum 16 through the drive transmission assembly 14, which is attached to the drive side end of the support frame 12. More specifically, the drive transmission assembly 14 is secured to the drive side support plate 22 of the support frame 12. The general design and configuration of the drive transmission assembly 14 may take the form of any power transmission device known in the art for transmitting the rotational power from the vehicle or equipment to which the implement 10 is attached (such as a hydraulic motor pump, motor and belt drive, or power take-off shaft) to the surface engaging rotary drum 16. That is, when the power generating device of the vehicle or equipment (such as a hydraulic motor pump, motor and belt drive, or power take-off shaft) is engaged and rotates, the rotational power is transferred to the surface engaging rotary drum 16 by the drive transmission assembly 14, thereby causing the rotary drum 16 to rotate. Alternatively, particularly in the case of walk, ride, or pull behind power equipment, the implement 10 may include a power source, such as a motor, that is used to rotate the rotary drum 16 directly, such that a vehicular power system is not necessary.

In one preferred embodiment of the implement 10, as best illustrated in FIG. 5, the drive transmission assembly 14 includes (1) a coupler that receives the equipment drive spindle from the power generating device of the equipment or vehicle; (2) a transmission sprocket, which rotates as the equipment drive spindle of the power generating device of the equipment or vehicle rotates; (3) the drive chain 38 or drive belt, which is driven by the transmission sprocket and which, in turn, drives the drive sprocket with key 26; and (4) a drive sprocket with key 26, which receives the drive spindle 28 of the surface engaging rotary drum 16 of the implement 10. The drive sprocket with key 26 receives the drive spindle 28, which includes a drive spindle keyway 30 that engages the drive sprocket with key 26. The drive spindle 28 extends through the drive bearing assembly 32, which includes the drive bearing 34. The drive bearing 34 allows the drive spindle 28 to rotate relative to the drive transmission assembly 14 (thereby rotating the rotary drum 16). The drive bearing housing 36 supports, positions, and protects the drive bearing 34 from dirt and debris. The drive chain 38, or alternatively the drive belt if a belt is utilized in place of the drive chain 38, engages both the transmission sprocket and the drive sprocket with key 26 and stretches between them, thereby causing the drive sprocket with key 26 to rotate as the transmission sprocket is rotated by the rotation of the equipment drive coupler by the power generating device of the equipment or vehicle. This, in turn, causes the drive spindle 28 to rotate and causes the surface engaging rotary drum 16 to rotate as well.

Most preferably, the drive bearing 34 is of a bearing type, or is otherwise configured in a way, that allows the drive spindle 28 to angle downward relative to the horizontal, thereby aiding in the removal of the rotary drum 16 pursuant to the present invention. For example, in one preferred embodiment of the implement 10 of the present invention, the drive bearing 34 is a spherical or ball insert bearing that may angle downward at an angle of approximately five (5) to fifteen (15) degrees. However, any type of bearing known in the art that allows for the downward deflection or angling of the drive spindle 28 once it has been inserted into the drive bearing 34 may be utilized without departing from the scope of the present invention.

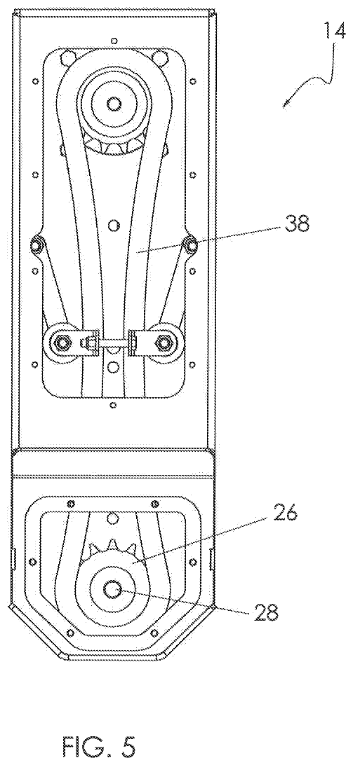

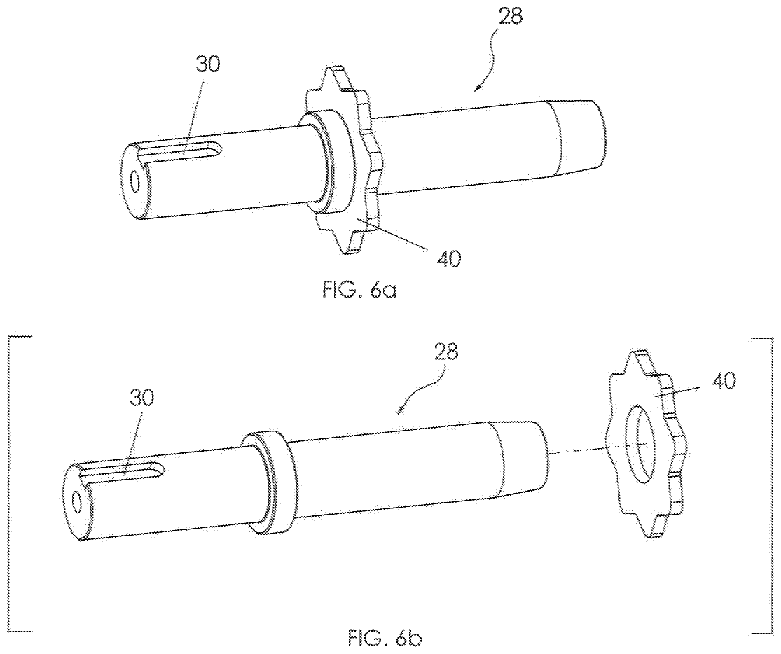

In one preferred embodiment of the implement 10 of the present invention, the drive spindle 28 also includes the male coupler 40 for engaging the surface engaging rotary drum 16. The male coupler 40 may take one of a variety of shapes or configurations for engaging the corresponding female coupler 54 of the surface engaging rotary drum 16. For example, in one embodiment of the present invention, the male coupler 40 of the drive spindle 28 has an eight-lobed spline configuration, as best shown in FIGS. 6a and 6b. Such a shape allows for strong and secure engagement between the drive spindle 28 and the surface engaging rotary drum 16 and allows torque to be transmitted to the surface engaging rotary drum 16 without slippage, while preventing dirt and debris from entering the female coupler 54 of the surface engaging rotary drum 16 and interfering with the end user's ability to quickly and easily attach or detach the surface engaging rotary drum 16 to or from the implement 10. However, many other shapes may also be used for the male coupler 40, including, but not limited to, triangular, rectangular or square, star, hexagonal, and octagonal shapes and the like.

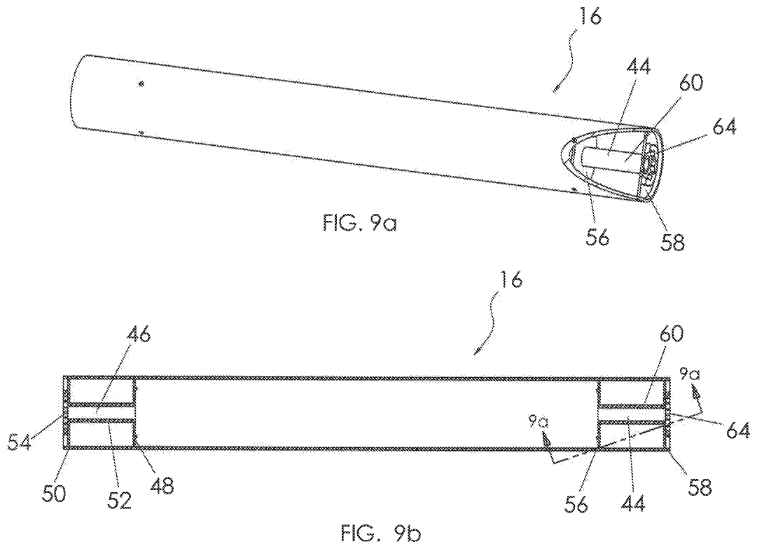

As best shown in FIGS. 9a and 9b, the surface engaging rotary drum 16 is of a generally cylindrical shape and includes the surface engagement tooling 42 of the implement 10, the idler side rotor hub assembly 44, and the drive side rotor hub assembly 46.

The outer surface of the surface engaging rotary drum 16 is designed to perform surface engagement work as the rotary drum 16 axially rotates. The surface engaging rotary drum 16 includes the desired surface engagement tooling 42 mounted along the outside surface or circumference of the rotary drum 16. The surface engagement tooling 42 is selected in accordance with the desired processing or surface treatment to be done by the implement 10 and may take any form known in the art for such tooling. As such, the configuration of the surface engagement tooling 42 may include, but is not limited to, tooling such as Y-shaped teeth, straight teeth, angled teeth, carbide tips, replaceable teeth, brooms or brushes, paddles, tines, and other similar tooling used in surface processing or treatment applications. Thus, the implement 10 of the present invention may utilize specific surface engagement tooling 42 selected in accordance with the desired processing of the surface to be done or the desired outcome of the completed work.

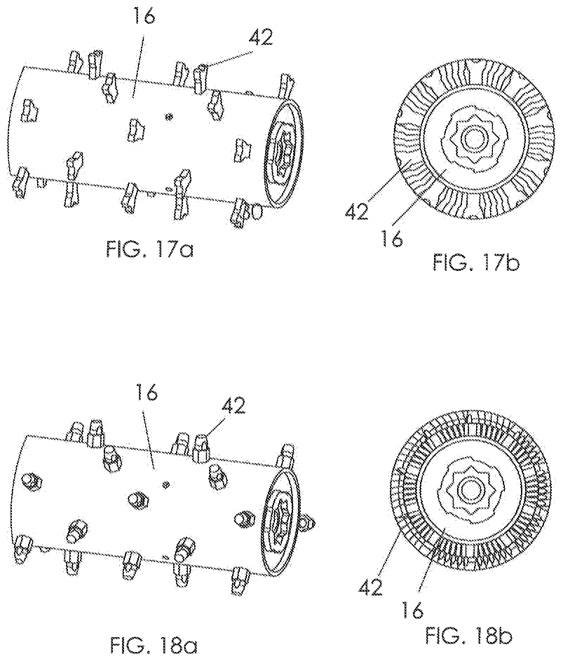

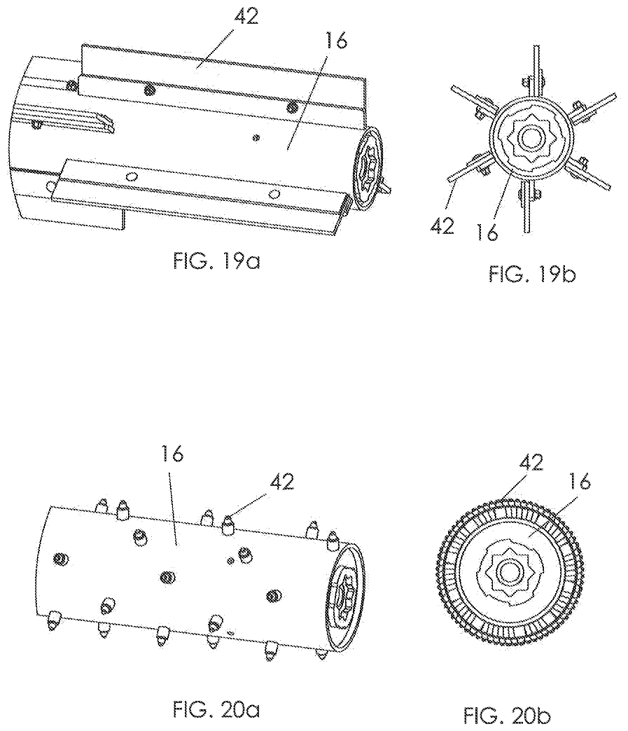

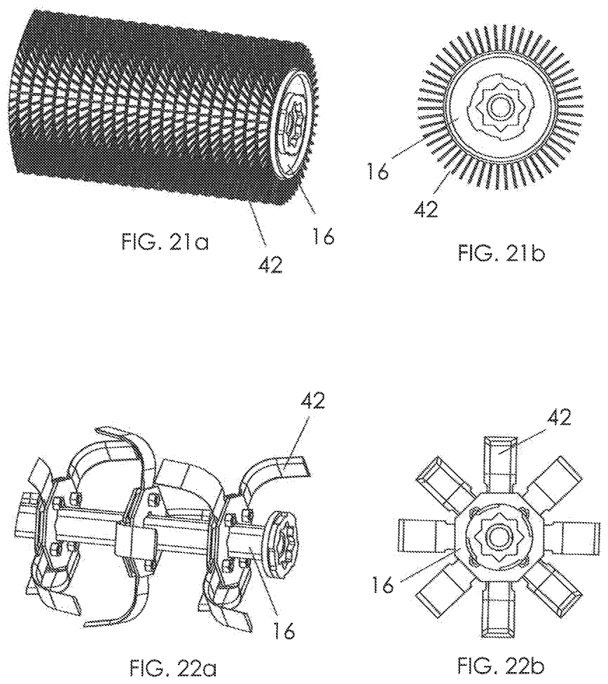

An exemplar selection of the various types of surface engaging rotary drums 16 with different types of surface engagement tooling 42 is shown in FIGS. 17a-22b, which illustrate some, but not all, of the possible surface engagement tooling 42 options the implement 10 of the present invention may utilize when interchanging the surface engaging rotary drum 16. FIGS. 17a and 17b show a surface engaging rotary drum 16 with surface engagement tooling 42 in the form of teeth having a “Y” shape to provide additional tool life to the surface engagement tooling 42. That is, when the surface engagement tooling 42 of the surface engaging rotary drum 16 has been worn down, the surface engaging rotary drum 16 may be reorientated 180 degrees on the support frame 12 (thereby “flipping” it end-to-end) to provide a completely fresh set of surface engagement tooling 42, thus lengthening the life of the surface engaging rotary drum 16 or allowing for greater use before the surface engagement tooling 42 must be replaced. FIGS. 18a and 18b show surface engagement tooling 42 with replaceable teeth which may also provide additional life to the surface engaging rotary drum 16 when the rotary drum 16 is reorientated 180 degrees on the support frame 12 (again, thereby “flipping” it end-to-end). FIGS. 19a and 19b show a paddle brush rotor for sweeping debris, like dirt, rocks, leaves, branches, and the like from surfaces. FIGS. 20a and 20b show an example of surface engagement tooling 42 with carbide tip teeth for a surface engaging rotary drum 16 and may be considered as the industry standard type of surface engagement tooling 42 for this type of implement 10. The surface engaging rotary drum 16 shown in FIGS. 20a and 20b may also benefit from additional surface engagement tooling 42 life when the surface engaging rotary drum 16 is reorientated 180 degrees on the support frame 12, as well as the end user benefiting from the improved time efficiency from having the ability to interchange the surface engaging rotary drum 16 for different uses. FIGS. 21a and 21b show a broom brush rotor for sweeping debris, like dirt, rocks, leaves, branches, and the like from surfaces. Finally, FIGS. 22a and 22b show a roto tine configured surface engaging rotary drum 16 which can be used to tine dirt or soil for landscaping, planting, or other purposes. These various options for the surface engagement tooling 42 of the surface engaging rotary drum 16 are more practical and useful with the implement 10 of the present invention due to the ability to quickly and easily replace or interchange the surface engaging rotary drum 16 of the implement 10 in accordance with the present invention, while the same are not feasible or practical with prior art implements due to the time and difficulty in removing and replacing or interchanging/exchanging one rotary drum for another in such implements.

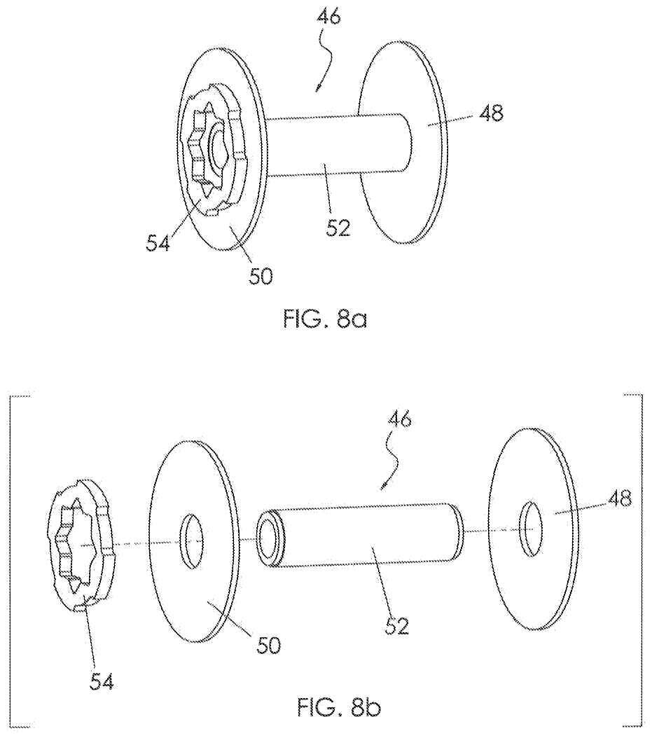

The drive side rotor hub assembly 46 is located inside of the surface engaging rotary drum 16 shell and, as best shown in FIGS. 8a and 8b, comprises the inner rotary drum spacer 48 and the outer rotary drum spacer 50, both of which secure the drive side rotor hub assembly 46 to the rotary drum 16. While the drive side rotor hub assembly 46 is typically secured to the surface engaging rotary drum 16 by welding the inner rotary drum spacer 48 and the outer rotary drum spacer 50 to the surface engaging rotary drum 16, the drive side rotor hub assembly 46 may alternatively be secured to the surface engaging rotary drum 16 through other means. The drive side rotor hub assembly 46 also includes the drive spindle receiving tube 52. The drive spindle receiving tube 52 is cylindrical in shape and is located along the longitudinal axis of the surface engaging rotary drum 16. The drive spindle receiving tube 52 receives the drive spindle 28 of the drive transmission assembly 14. The drive side rotor hub assembly 46 further comprises the female coupler 54, which is adjacent to, and secured to, the outer surface of the outer rotary drum spacer 50 and surrounds the drive spindle receiving tube 52. The female coupler 54 receives the male coupler 40 of the drive spindle 28. As such, the female coupler 54 has a shape or configuration that corresponds with the shape or configuration of the male coupler 40 of the drive spindle 28, such that the male coupler 40 may be received and engaged by, and therefore transmit rotational power to, the surface engaging rotary drum 16. For example, in one embodiment of the present invention, the female coupler 54 has an eight-lobed spline configuration that corresponds with the eight-lobed spline configuration of the male coupler 40. Such a shape allows for strong and secure engagement between the drive spindle 28 and the surface engaging rotary drum 16 and allows torque to be transmitted to the surface engaging rotary drum 16 without slippage, while preventing dirt and debris from entering the female coupler 54 of the surface engaging rotary drum 16 and interfering with the end user's ability to quickly and easily attach or detach the surface engaging rotary drum 16 to or from the implement 10. However, similar to the male coupler 40, the female coupler 54 may take many other different shapes if a different shape is used for the male coupler 40; this includes, but is not limited to, triangular, rectangular or square, star, hexagonal, and octagonal shapes and the like. The male coupler 40 of the drive spindle 28 and the female coupler 54 of the drive side rotor hub assembly 46 create a linkage for transmitting torque and rotational power to the surface engaging rotary drum 16, while also providing a means of release for the rotary drum 16.

The female coupler 54 has an accepting cavity for receiving the male coupler 40 that is shaped to correspond to the shape of the perimeter of the male coupler 40 (for example, the eight-lobed spline shape discussed in connection with one embodiment of the present invention). The depth of the receiving cavity of the female coupler 54 is predetermined to provide for adequate engagement of the male coupler 40 of the drive spindle 28 to allow the drive spindle 28 to engage and securely rotate the surface engaging rotary drum 16.

The surface engaging rotary drum 16 also includes the idler side rotor hub assembly 44, which corresponds in basic structure to the drive side rotor hub assembly 46 as best shown in FIGS. 8a and 8b (and otherwise as shown in FIGS. 9a and 9b), comprises the inner rotary drum spacer 56 and the outer rotary drum spacer 58, both of which are located inside of the rotary drum 16. The inner rotary drum spacer 56 and the outer rotary drum spacer 58 secure the idler side rotor hub assembly 44 to the surface engaging rotary drum 16. While the idler side rotor hub assembly 44 is typically secured to the surface engaging rotary drum 16 by welding the inner rotary drum spacer 56 and the outer rotary drum spacer 58 to the surface engaging rotary drum 16, the idler side rotor hub assembly 44 may alternatively be secured to the surface engaging rotary drum 16 through other means. The idler side rotor hub assembly 44 also includes the idler spindle receiving tube 60, which is cylindrical in shape and is configured to receive the idler spindle 62 of the idler carrier assembly 18. The idler side rotor hub assembly 44 further comprises a female coupler 64, which is adjacent to, and secured to, the outer rotary drum spacer 58 and surrounds the idler spindle receiving tube 60. The female coupler 64 receives the male coupler 66 of the idler spindle 62. The female coupler 64 has a shape or configuration that corresponds with the shape or configuration of the male coupler 66 of the idler spindle 62, such that the male coupler 66 may be received and held by the surface engaging rotary drum 16. For example, in one embodiment of the present invention, the female coupler 64 has an eight-lobed spline configuration that corresponds with the eight-lobed spline configuration of the male coupler 66. Such a shape allows for strong and secure engagement between the idler spindle 62 and the surface engaging rotary drum 16, while preventing dirt and debris from entering the female coupler 64 of the surface engaging rotary drum 16 and interfering with the end user's ability to quickly and easily attach or detach the surface engaging rotary drum 16 to or from the implement 10. However, similar to the male coupler 66, the female coupler 64 may take many other different shapes if a different shape is used for the male coupler 66; this includes, but is not limited to, triangular, rectangular or square, star, hexagonal, and octagonal shapes and the like. The male coupler 66 of the idler spindle 62 and the female coupler 64 of the idler side rotor hub assembly 44 create a linkage between the surface engaging rotary drum 16 and the idler carrier assembly 18, while also providing a means of release for the rotary drum 16.

The female coupler 64 has an accepting cavity for receiving the male coupler 66 that is shaped to correspond to the shape of the perimeter of the male coupler 66 (for example, the eight-lobed spline shape discussed in connection with one embodiment of the present invention). The depth of the receiving cavity of the female coupler 64 is predetermined to provide for adequate engagement of the male coupler 66 of the idler spindle 62 to allow the idler spindle 62 to engage and securely rotate with the surface engaging rotary drum 16.

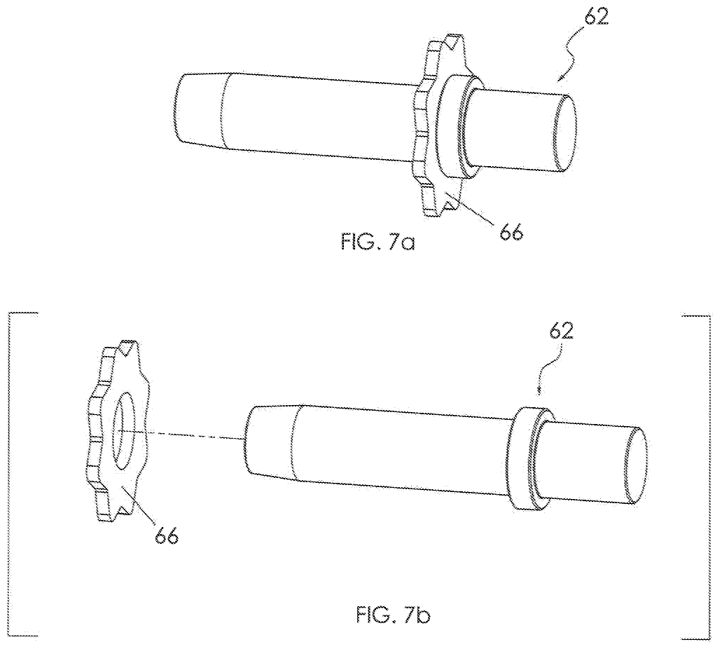

The idler spindle 62 also includes the male coupler 66 that is accepted by and engages the female coupler 64 of the surface engaging rotary drum 16. Similar to the male coupler 40 of the drive spindle 28, the male coupler 66 can have a variety of shapes or configurations for engaging the surface engaging rotary drum 16. For example, in one embodiment of the present invention, the male coupler 66 of the idler spindle 62 has an eight-lobed spline configuration, as best shown in FIGS. 7a and 7b. Such a shape allows for strong and secure engagement between the idler spindle 62 and the surface engaging rotary drum 16, while preventing dirt and debris from entering the female coupler 64 of the surface engaging rotary drum 16 and interfering with the end user's ability to quickly and easily attach or detach the surface engaging rotary drum 16 to or from the implement 10. However, many other shapes may also be used for the male coupler 66, including, but not limited to, triangular, rectangular or square, star, hexagonal, and octagonal shapes and the like.

Preferably, the male coupler 40 of the drive spindle 28 and the male coupler 66 of the idler spindle 62 have the same size and general shape or configuration. Similarly, preferably, the female coupler 54 of the drive side rotor hub assembly 46 and the female coupler 64 of the idler side rotor hub assembly 44 have the same size and general shape or configuration, which corresponds to the size and shape or configuration of the male coupler 40 of the drive spindle 28 and the male coupler 66 of the idler spindle 62. This is done so that the ends of the surface engaging rotary drum 16 are interchangeable. That is, in such a case, the surface engaging rotary drum 16 may be flipped about its transverse axis, such that the drive side end of the surface engaging rotary drum 16 becomes the idler side end of the surface engaging rotary drum 16 and the idler side end of the surface engaging rotary drum 16 becomes the drive side end of the surface engaging rotary drum 16. An end user may want to utilize such a capability for a number of reasons. For example, it may be desirable to flip the surface engaging rotary drum 16 to equalize wear on each side of the surface engagement tooling 42 or if the surface engagement tooling 42 is configured to have different processing outcomes depending upon the direction of rotation of the surface engaging rotary drum 16. However, where such a capability is not desirable or necessary, the male coupler 40 of the drive spindle 28 and the male coupler 66 of the idler spindle 62 (and the female coupler 54 of the drive side rotor hub assembly 46 and the female coupler 64 of the idler side rotor hub assembly 44) may have differing sizes, shapes, or configurations.

The idler carrier assembly 18 is removably secured to the idler side of the support frame 12. More specifically, the idler carrier assembly 18 is removably secured to the idler side support plate 24 of the support frame 12. Preferably, the idler side support plate 24 includes a plurality of alignment pins that are received by alignment apertures of the idler carrier assembly 18, which allow the idler carrier assembly 18 to be properly located adjacent and congruent to the idler side support plate 24. However, alternatively, the idler carrier assembly 18 may include a plurality of alignment pins that are received by alignment apertures of the idler side support plate 24, which similarly allow the idler carrier assembly 18 to be properly located adjacent and congruent to the idler side support plate 24. The idler carrier assembly 18 is then removably secured to the idler side support plate 24 with a plurality of bolts 68. When the bolts 68 are secured to the idler side support plate 24, the idler carrier assembly 18 holds the surface engaging rotary drum 16 in the proper location for use of the implement 10. However, the bolts 68 may also be removed to allow the idler carrier assembly 18 to be removed from the idler side support plate 24 to remove or exchange the surface engaging rotary drum 16.

It should be recognized by one skilled in the art that although the idler carrier assembly 18 is illustrated in the figures as preferably being secured to the side of the idler side support plate 24, alternatively, the idler carrier assembly 18 may be secured to the idler side support plate 24 in different positions on the idler side support plate 24 without departing from the scope of the present invention, For example, the idler carrier assembly 18 may alternatively be secured to the bottom of the idler side support plate 24 if a shorter idler side support plate 24 is utilized, in such a circumstance, the idler carrier assembly 18 would be secured to the idler side support plate 24 with bolts extending vertically through the bottom of the idler side support plate 24 and the top of the idler carrier assembly 18.

The idler carrier assembly 18 also includes the idler bearing assembly 70. The idler bearing assembly 70 includes the idler bearing 72, which allows the idler spindle 62 to rotate relative to the idler carrier assembly 18 (thereby also allowing the rotary drum 16 to rotate), and the idler bearing housing 74, which supports, positions, and protects the idler bearing 72 from dirt and debris. The idler spindle 62 extends through the idler bearing 72 and is received by the idler spindle receiving tube 60 of the idler side rotor hub assembly 44.

Most preferably, the idler bearing 72 is of a bearing type, or is otherwise configured in a way, that the idler spindle 62 may angle downward relative to the horizontal, thereby aiding in the removal of the rotary drum 16 pursuant to the present invention. For example, in one preferred embodiment of the implement 10 of the present invention, the idler bearing 72 is a spherical or ball insert bearing that may angle downward at an angle of approximately five (5) to fifteen (15) degrees, However, any type of bearing known in the art that allows for the downward deflection or angling of the idler spindle 62 once it has been inserted into the idler bearing 72 may be utilized without departing from the scope of the present invention. Likewise, alternatively, the idler bearing 72 may be configured to have a fixed horizontal configuration, such that it does not and cannot be angled relative to the horizontal, while not departing from the scope of the present invention, as such a configuration still allows the removal of the idler carrier assembly 18 with some additional effort.

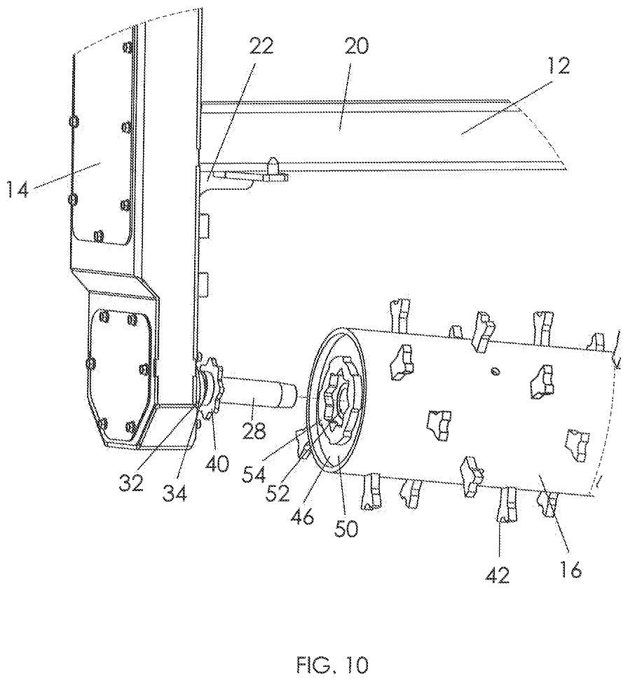

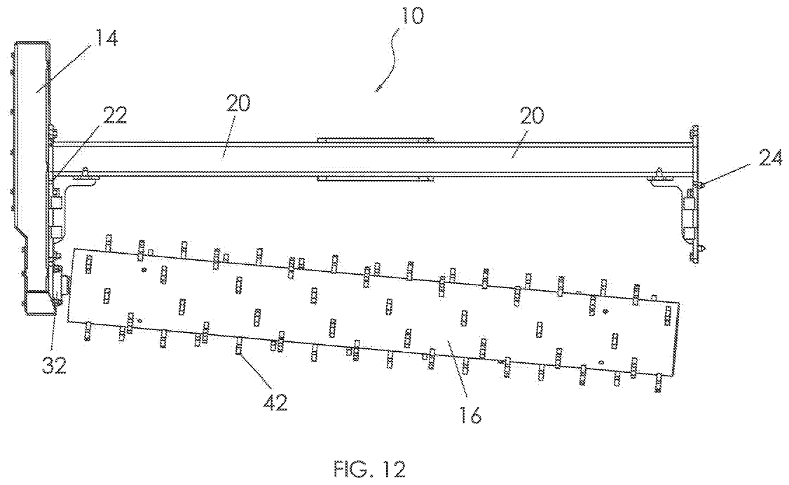

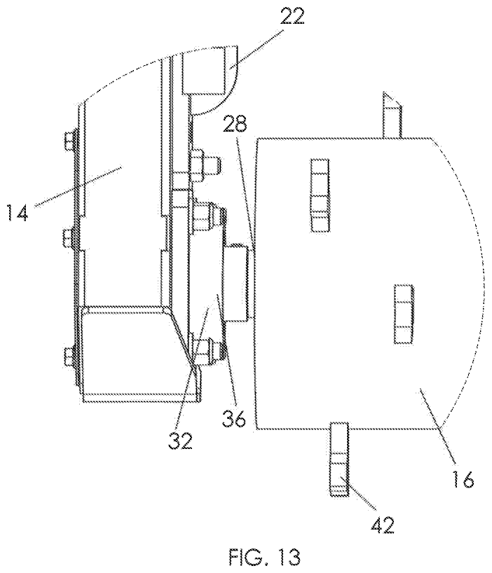

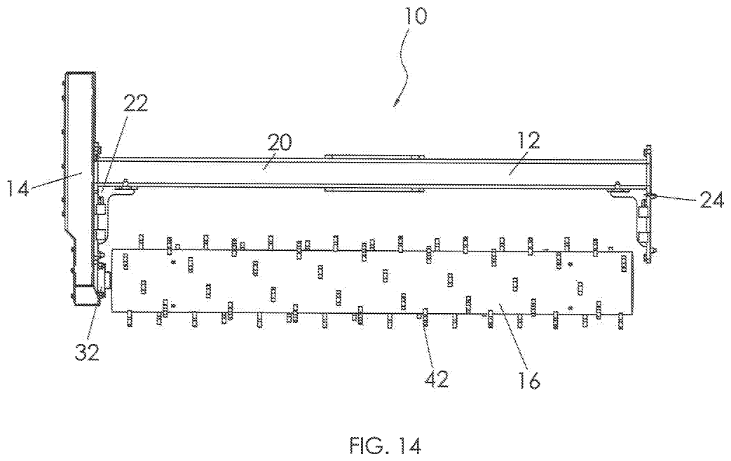

One aspect of one preferred embodiment of the implement 10 of the present invention is the reduction in the time and effort required to replace or interchange the surface engaging rotary drum 16 of the implement 10 in comparison to prior art implements. To attach the surface engaging rotary drum 16 to the support frame 12 (and therefore the implement 10 of the present invention), the drive spindle 28 is first inserted into the spindle receiving tube 52 of the drive side rotor hub assembly 46, as best illustrated in FIGS. 10 and 12. The male coupler 40 of the drive spindle 28 may then be rotated as necessary to fit into and be engaged by the female coupler 54, or other such drive transmission mechanism, of the drive side rotor hub assembly 46. After the drive spindle 28 has been mated with the drive side rotor hub assembly 46, the surface engaging rotary drum 16 is re-positioned to be approximately parallel to and substantially beneath the horizontal support bar 20 of the support frame 12, as best shown in FIGS. 13 and 14.

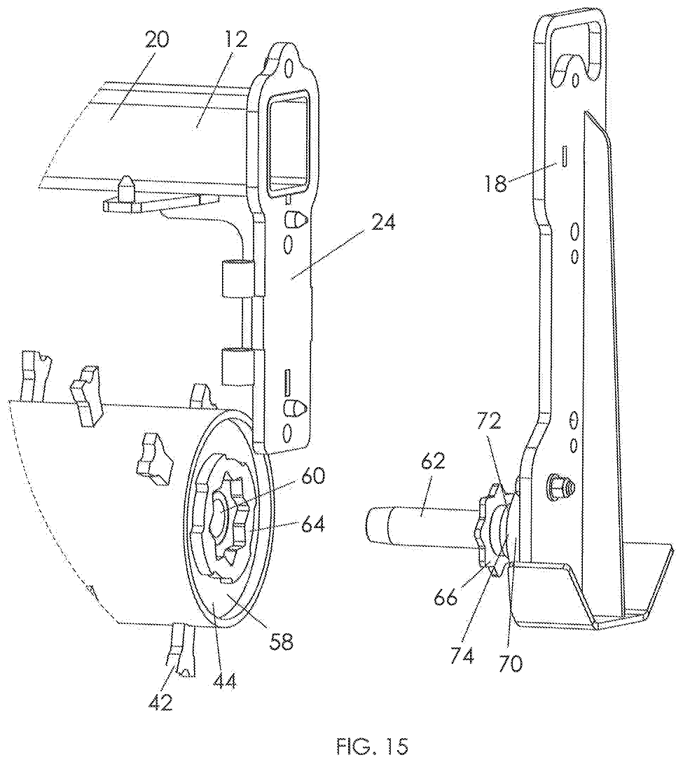

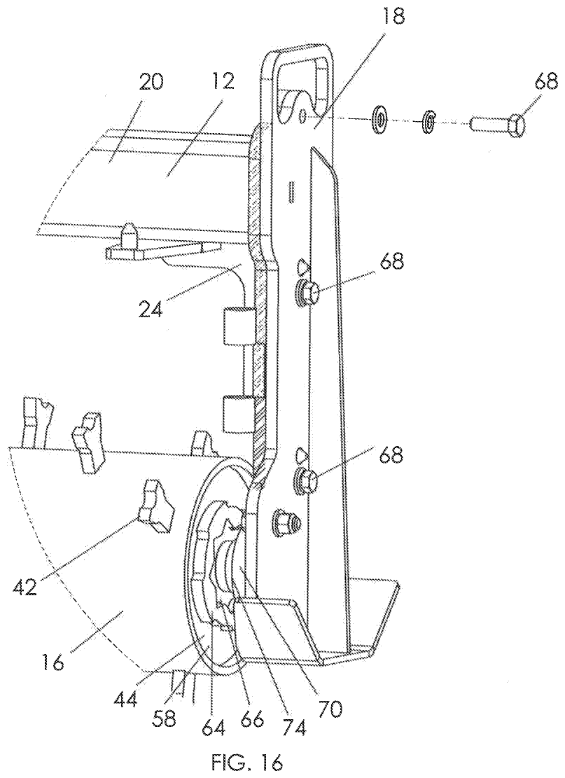

Next, as best shown in FIGS. 3 and 15, the idler carrier assembly 18 with the idler spindle 62 is positioned to allow the idler spindle 62 to be inserted into the spindle receiving tube 60 of the idler side rotor hub assembly 44. The idler carrier assembly 18 is adjusted such that the alignment apertures of the idler carrier assembly 18 correspond with the positions of the alignment pins of the idler side support plate 24 of the support frame 12. Once each of the alignment apertures have been aligned with their corresponding alignment pins, the male coupler 66 of the idler spindle 62 may be rotated as necessary to fit into and be engaged by the female coupler 64 of the idler side rotor hub assembly 44. After the idler side rotor hub assembly 44 has been mated with the idler spindle 62, the bolts or fasteners are then inserted through bolt or fastener apertures in the idler carrier assembly 18 and idler side support plate 24 and tightened to attach and secure the idler carrier assembly 18 to the idler side support plate 24 of the support frame 12, as best illustrated in FIG. 16. Thus, the surface engaging rotary drum 16 is secured to the implement 10.

Securing the idler carrier assembly 18 to the idler side support plate 24 results in the sandwiching of the drive spindle 28, idler spindle 62, and surface engaging rotary drum 16 between the drive side support plate 22 (and associated drive transmission assembly 14) and the idler side support plate 24 within the support frame 12 of the implement 10. This completed assembly secures the surface engaging rotary drum 16 within the support frame 12 and allows torque to be transmitted from the vehicle's rotational power supply, through the drive transmission assembly 14, and then through the drive spindle 28 to the surface engaging rotary drum 16 to impart rotational energy to the surface engaging rotary drum 16 to perform the desired work.

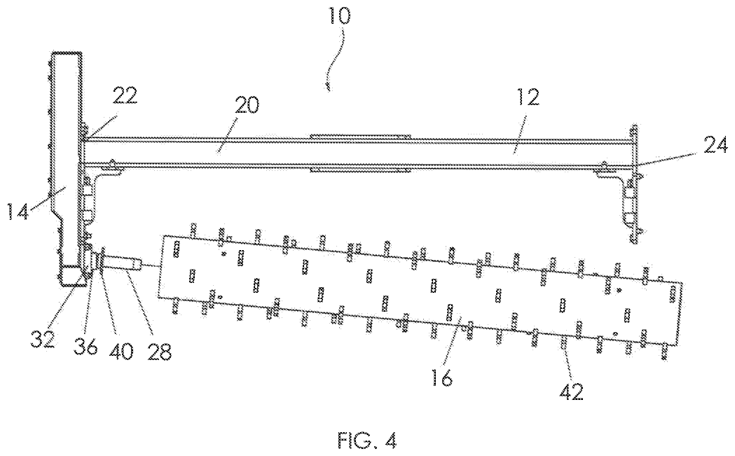

Therefore, the design of the implement 10 of the present invention allows an end user to quickly and easily replace or interchange rotary drums by following the reverse process to detach (and then replace or interchange) the surface engaging rotary drum 16, as best shown in FIG. 4.

First, for safety reasons, the end user places some type of support (like wooden blocks, a jack, or other support means) under the surface engaging rotary drum 16, so that the rotary drum 16 does not fall from the implement 10 in an uncontrolled manner. The end user then loosens and removes the bolts or fasteners attaching the idler carrier assembly 18 to the idler side support plate 24 of the support frame 12. Then, the idler carrier assembly 18 is moved longitudinally away from the idler side support plate 24, thereby removing the alignment pins of the idler side support plate 24 from the alignment apertures of the idler carrier assembly 18. This movement also allows the idler spindle 62 to be withdrawn and removed from the idler spindle receiving tube 60 of the idler side rotor hub assembly 44.

The drive bearing 34 and drive bearing housing 36 then allow the drive spindle 28 to pitch slightly downward relative to the horizontal plane. The resulting downward shift of the opposite end (on the idler side support plate 24 side) of the surface engaging rotary drum 16 is sufficient to provide enough clearance for the surface engaging rotary drum 16 to longitudinally slide or be shifted off of, and disengage from, the drive spindle 28, thereby removing the drive spindle 28 from the drive spindle receiving tube 52 of the drive side rotor hub assembly 46.

Once the surface engaging rotary drum 16 has been removed from the implement 10, service may be performed on the rotary drum 16 (and after that is complete, the rotary drum 16 may be reinstalled on the implement 10) or a different application-specific rotary drum 16 may be installed on the implement 10.

It will be recognized by one skilled in the art that the size, configuration, or dimensions of the implement 10 of the present invention and the components thereof may be adjusted to allow for use with various sizes of vehicles and rotary drums 16, as may be desired by the end user of the implement. Likewise, it will be recognized by one skilled in the art that the materials from which the implement 10 of the present invention is made may be varied without departing from the scope of the present invention.

While the invention has been described in the specification and illustrated in the drawings with reference to certain, preferred embodiments, it will be understood by those skilled in the art that various changes may be made and equivalents may be substituted for elements thereof without departing from the scope of the present invention. In addition, many modifications may be made to adapt to a particular situation or material to the teachings of the invention without departing from the essential scope thereof. Therefore, it is intended that the present invention not be limited to the particular embodiments illustrated by the drawings and described in the specification as the best modes presently contemplated for carrying out the present invention, but that the present invention will include any embodiments falling within the description of the invention herein and claims appended hereto.

What is claimed is:

1. An implement for a vehicle comprising:
(a) support frame comprising a horizontal support bar, a drive side support plate extending from a first end of the horizontal support bar, and an idler side support plate extending from a second end of the horizontal support bar;
(b) a drive transmission assembly secured to the drive side support plate of the support frame, wherein the drive transmission assembly includes a drive bearing through which a drive spindle extends and wherein the drive transmission assembly transmits torque from the vehicle to the drive spindle;
(c) an idler carrier assembly removably secured to the idler side support plate of the support frame, wherein the idler carrier assembly includes an idler bearing through which an idler spindle extends;
(d) a surface engaging rotary drum removably secured to the drive transmission assembly and the idler carrier assembly; and
wherein the drive bearing is a spherical bearing that allows the drive spindle to he angled relative to the horizontal support bar without being removed from the drive transmission assembly;
wherein the drive spindle includes a male coupler of a predetermined shape; and
wherein at least one end of the surface engaging rotary drum includes a female coupler of a predetermined shape, wherein the female coupler comprises a cavity in the at least one end of the surface engaging rotary drum having the predetermined shape, and wherein the predetermined shape of the female coupler corresponds with the predetermined shape of the male coupler, such that the male coupler extends into and engages with the female coupler and wherein the surface engaging rotary drum includes an outer surface that includes surface engagement tooling for processing a surface.

2. The implement of claim 1, wherein the idler side support plate includes at least one alignment pin and the idler carrier assembly includes at least one alignment aperture and the idler carrier assembly is removably secured to the support frame by extending the at least one alignment pin through the at least one alignment aperture.

3. The implement of claim 2, wherein the at least one alignment pin comprises a plurality of alignment pins, the at least one alignment aperture comprises a plurality of alignment apertures, and the idler carrier assembly is removably secured to the support frame by extending the plurality of the alignment pins through the plurality of alignment apertures.

4. The implement of claim 1, wherein the idler side support plate includes at least one alignment aperture and the idler carrier assembly includes at least one alignment pin, and the idler carrier assembly is removably secured to the support frame by extending the at least one alignment pin through the at least one alignment aperture.

5. The implement of claim 4, wherein the at least one alignment aperture of the idler side support plate comprises a plurality of alignment apertures, the at least one alignment pin of the idler carrier assembly comprises a plurality of alignment pins, and the idler carrier assembly is removably secured to the support frame by extending the plurality of the alignment pins through the plurality of alignment apertures.

6. The implement of claim 1, further comprising an attachment mount for removably securing the implement to a vehicle.

7. The implement of claim 6, wherein the attachment mount comprises a universal mounting adapter.

8. The implement of claim 6, wherein the attachment mount comprises a three-point hitch system.

9. The implement of claim 1, wherein the drive transmission assembly includes a drive sprocket, the drive sprocket includes a key, the drive spindle includes a keyway, and the key of the drive sprocket is received by the keyway of the drive spindle.

10. The implement of claim 1, wherein the idler bearing is a spherical bearing that allows the drive spindle to be angled relative to the horizontal support bar without being removed from the idler carrier assembly.

11. The implement of claim 1, wherein the idler spindle includes a male coupler of a predetermined shape and wherein each end of the surface engaging rotary drum includes a female coupler of a predetermined shape, wherein the predetermined shape of the female coupler corresponds with the predetermined shape of the male coupler of the drive spindle and the male coupler of the idler spindle, such that the male coupler of the drive spindle extends into and engages with the female coupler of the first end of the surface engaging rotary drum and the male coupler of the idler spindle extends into and engages with the female coupler of the second end of the surface engaging rotary drum.

12. The implement of claim 1, wherein the surface engaging rotary drum includes a first end and a second end, wherein the surface engaging rotary drum has a first configuration and a second configuration such that when the implement is in its second configuration the surface engaging rotary drum has been rotated in the radial direction by one hundred eighty degrees from the surface engaging rotary drum's position when the implement is in its first configuration, wherein the first end of the surface engaging rotary drum engages the drive spindle when the implement is in its first configuration and engages the idler spindle when the implement is in its second configuration, and wherein the second end of the surface engaging rotary drum engages the idler spindle when the implement is in its first configuration and engages the drive spindle when the implement is in its second configuration.

13. The implement of claim 1, wherein the surface engaging rotary drum includes a drive spindle receiving tube for receiving the drive spindle and an idler spindle receiving tube for receiving the idler spindle.

14. The implement of claim 13, wherein the drive spindle receiving tube extends from the female coupler of the surface engaging rotary drum.

15. The implement of claim 11, wherein the surface engaging rotary drum includes a drive spindle receiving tube at a first end of the surface engaging rotary drum for receiving the drive spindle and an idler spindle receiving tube at a second end of the surface engaging rotary drum for receiving the idler spindle.

16. The implement of claim 15, wherein the drive spindle receiving tube extends from the female coupler at the first end of the surface engaging rotary drum and the idler spindle receiving tube extends from the female coupler at the second end of the surface engaging rotary drum.

17. The implement of claim 1, wherein the male coupler of the drive spindle is offset from an end of the drive spindle.

18. The implement of claim 11, wherein the male coupler of the drive spindle is offset from an end of the drive spindle and the male coupler of the idler spindle is offset from an end of the idler spindle.

19. The implement of claim 1, wherein the predetermined shape of the male coupler of the drive spindle includes a plurality of lobes and the female coupler of the surface engaging rotary drum includes a plurality of lobes.

20. The implement of claim 11, wherein the predetermined shape of the male coupler of the drive spindle includes a plurality of lobes, the predetermined shape of the male coupler of the idler spindle includes a plurality of lobes, and the female coupler at each end of the surface engaging rotary drum includes a plurality of lobes.
